(19) United States
(12) Patent Application Publication
(10) Pub. No.: US 2010/0180804 A1
(43) Pub. Date: Jul. 22, 2010

(54) LOCKING ENCLOSURE

(75) Inventors: Scott Czarnecki, Mukwonago, WI (US); Dean D. Hacker, Oak Creek, WI (US)

Correspondence Address: CALFEE, HALTER & GRISWOLD LLP, 1400 KEYBANK CENTER, 800 SUPERIOR AVENUE, CLEVELAND, OH, 44114, US

(73) Assignee: MASTER LOCK COMPANY LLC, Oak Creek, WI (US)

(21) Appl. No.: 12/539,024

(22) Filed: Aug. 11, 2009

Related U.S. Application Data
(60) Provisional application No. 61/087,848, filed on Aug. 11, 2008.

(51) Int. Cl. E05G 1/02

(52) U.S. Cl. 109/45; 109/53

(57) ABSTRACT

A cash box for storing paper notes and coins is disclosed. In one embodiment, the cash box includes a housing having a base and four side walls, a lid fixed to the housing and movable between opened and closed positions to restrict access to a tray within an upper cavity of the housing, a drawer movable between a closed position within a lower cavity of the housing and an opened position at least partially extending from the housing. A locking mechanism may prohibit access to the tray when locking the lid in a closed position. A coin storage holder may be included which is detachably engaged to one of the four side walls.

### CROSS-REFERENCE TO RELATED APPLICATION

This application claims the benefit of U.S. Provisional Patent Application Ser. No. 61/087,848, entitled “LOCKING ENCLOSURE” and filed Aug. 11, 2008, the entire contents of which are incorporated herein by reference, to the extent that they are not conflicting with the present application.

### BACKGROUND

Locking enclosures are used in many indoor and outdoor environments to restrict access to various items by providing the enclosure with a lockable door, lid, drawer, or other such barrier. The barrier can include a locking mechanism, such as for example, a combination lock, padlock, or key operated latch, to limit access to the contents of the enclosure to one or more authorized users. Some applications may require secure storage and organization of a number of smaller items, such as jewelry, keys, or money. One example of such an enclosure is a cash box, in which a partitioned enclosure may allow for separation and organization of different denominations of money. A conventional cash box may include a lockable lid and a removable tray having multiple compartments for separating and storing different coins or paper money. The cash box enclosure may be deep enough to store additional items under the removable tray, such as for example, valuable papers (e.g., personal checks or stock certificates) or other items for which a tray compartment has not been dedicated. To access these items, the tray must be lifted and/or removed from the cash box, which may be inconvenient and may result in a greater risk of loss or theft of the items stored in the tray.

### SUMMARY OF THE INVENTION

In an illustrated embodiment of the invention, a locking enclosure is disclosed. The locking enclosure is for use to provide portable and efficient storage of paper notes and coins.

A locking enclosure is disclosed. In one embodiment, the locking disclosure includes a housing defining an opening, a first access barrier movable between opened and closed positions to restrict access to an upper cavity within the housing, a second access barrier movable between opened and closed positions to restrict access to a lower cavity within the housing, and a locking mechanism that prohibits access to at least one of the upper cavity and the lower cavity when locked. The enclosure may include a detachable storage compartment engaged to an outside surface of the housing.

### BRIEF DESCRIPTION OF THE DRAWINGS

Further features and advantages of the invention will become apparent from the following detailed description made with reference to the accompanying drawings, wherein:

FIG. 1 illustrates a perspective view of a locking enclosure, shown with the lid in an opened position;

FIG. 2 illustrates a side perspective view of the locking enclosure of FIG. 1, shown with the lid in an opened position;

FIG. 3 illustrates a side perspective view of the locking enclosure of FIG. 1, shown with the lid and drawer in opened positions, with a portion of the housing removed to illustrate additional features of the locking enclosure;

FIG. 4 illustrates a lower side perspective view of the locking enclosure of FIG. 1, shown with the lid in a closed position, with a portion of the housing removed to illustrate additional features of the locking enclosure;

FIG. 5 illustrates a lower side perspective view of the locking enclosure of FIG. 1, shown with the lid in an opened position, with a portion of the housing removed to illustrate additional features of the locking enclosure;

FIG. 6 is an upper perspective view of the locking enclosure of FIG. 1, shown with the lid in an opened position;

FIG. 7 is a partial side perspective view of the locking enclosure of FIG. 1, shown with the coin holder in a detached condition;

FIG. 8A is an upper view of a coin holder attachment portion of the locking enclosure of FIG. 1, shown with the coin holder removed;

FIG. 8B is an upper view of the coin holder attachment portion of the locking enclosure of FIG. 1, shown with the coin holder separated from the enclosure; and

FIG. 8C is an upper view of the coin holder attachment portion of the locking enclosure of FIG. 1, shown with the coin holder attached to the enclosure.

### DETAILED DESCRIPTION

This Detailed Description of the Invention merely describes embodiments of the invention and is not intended to limit the scope of the claims in any way. Indeed, the invention as described is broader than and unlimited by the preferred embodiments, and the terms used have their full ordinary meaning.

According to an aspect of the present application, a locking enclosure may be provided with a first access barrier that restricts access to a first cavity within the enclosure, and a second access barrier that restricts access to a second cavity within the enclosure. In one embodiment, a first, upper access barrier includes a lockable lid (as may be used, for example, with a cash box), and a second, lower access barrier includes a lockable drawer. The contents of a first, upper cavity of the enclosure may be stored, for example, in a tray retained within the upper cavity. By providing a separate lower cavity with a separate external access barrier, contents of the lower cavity may be accessed without removing the tray (or its contents) from the enclosure. Both the tray and the drawer may be provided with multiple compartments for storing, separating, and organizing items, such as, for example, various denominations of coins and paper money. Further, a detachable storage compartment engaged to an outside surface of the enclosure.

While a locking enclosure having multiple access barriers may be provided with a separate locking mechanism for each access barrier or with a locking mechanism that operates to unlock multiple access barriers sequentially or simultaneously, in one embodiment, a locking enclosure may include a first access barrier provided with a locking mechanism, and a second access barrier being movable to an opened position only when the first access barrier has been unlocked and moved to an opened position.

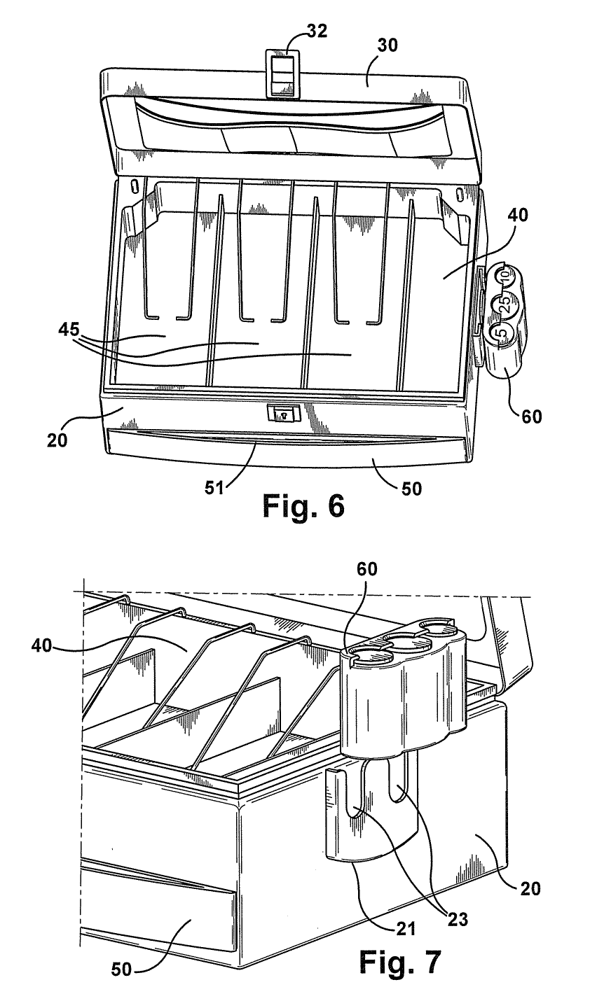

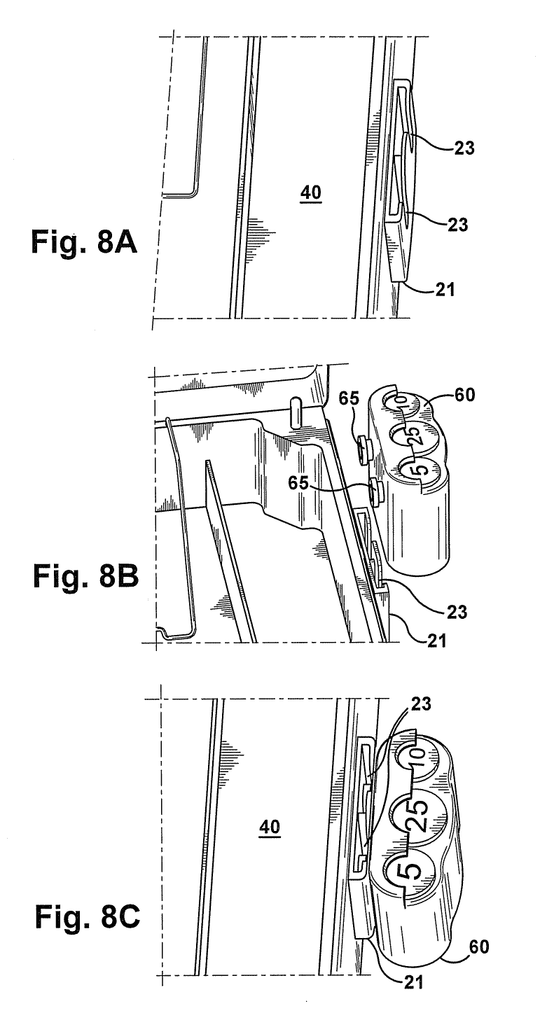

FIGS. 1-8C illustrate various views of an exemplary locking enclosure 10 adapted for use as a cash box. The locking enclosure includes an outer housing 20, an upper access barrier or lid 30 hingedly connected to the housing 20, a tray 40 disposed within an upper cavity of the enclosure 10, and a lower access barrier or drawer 50 stored within a lower cavity of the enclosure 10. The housing as shown includes a base and four side walls that form a five sided enclosure having an opening at the top. While any suitable locking mechanism may be used to lock the lid 30 in a closed position (e.g., a combination lock or a padlock and hasp), the exemplary lid 30 includes a latch member 32 configured to be lockingly engaged by a key operated latch base 22 secured to the outer housing 20, as used with conventional cash boxes.

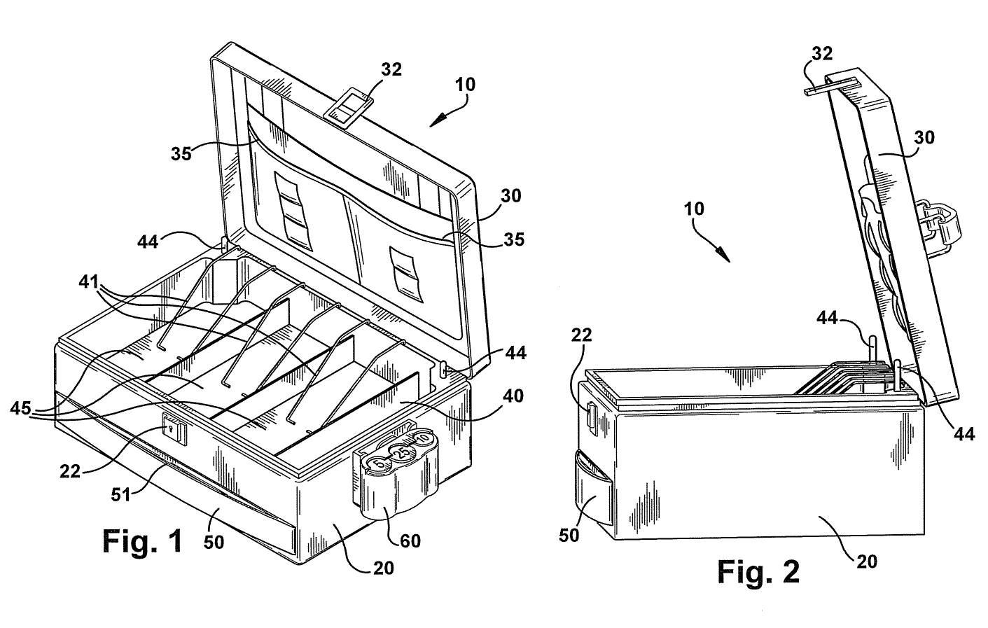

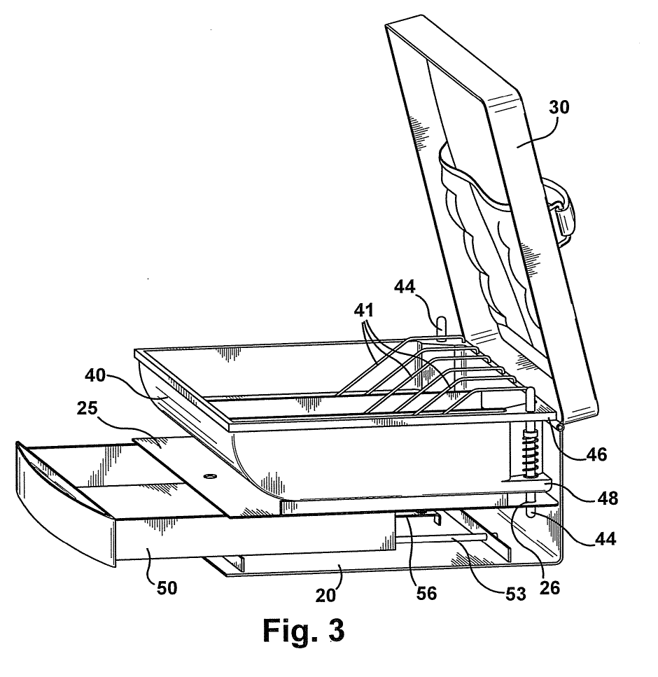

The drawer 50 is slidable between a closed position (FIGS. 1 and 2) and an opened position (FIG. 3) to store and access contents of the drawer 50. As shown in FIG. 3, the drawer 50 may slide along rods or rails 53 secured to the floor of the housing 20. A partition member 25 (see FIG. 3) is secured to the housing 20 to support the tray 40 and to allow the drawer 50 to slide freely into and out of the lower cavity of the enclosure 10. The exemplary drawer 50 includes a graspable handle 51 to facilitate opening the drawer.

To inhibit unauthorized access to the drawer, a locking mechanism may be configured to lockingly engage the drawer to secure the drawer in the closed position. While the locking mechanism may include a user operable lock (such as, for example, the latch 22, 32 provided with the lid 30), the locking mechanism may instead be associated with the lid, such that when the lid 30 is opened, the locking mechanism automatically moves from a locked condition to an unlocked condition to allow the drawer to be opened.

In one embodiment, a drawer locking mechanism for a locking enclosure includes one or more locking members (e.g., pivotable clasps or slidable posts) configured to retain a drawer in a closed position when a lid (or other such access barrier) is retained in a closed position. The locking enclosure may be configured such that movement of the lid from the closed position to the opened position disengages the locking members from the drawer to allow movement of the drawer. When the drawer is returned to the closed position, movement of the lid from the opened position to the closed position returns the locking members to direct or indirect locking engagement with the drawer.

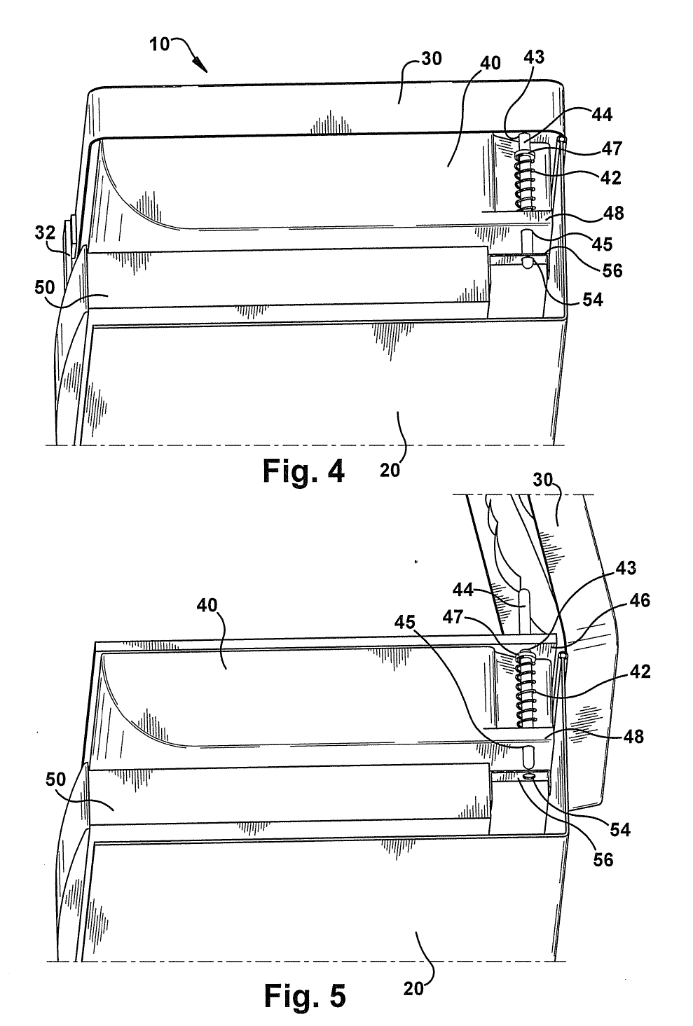

Locking members for securing a drawer in a closed position may be provided in any suitable shape, location, and orientation, and configured for any suitable movement (e.g., sliding, pivoting, or rotating). In the illustrated embodiment, locking members include elongated pins 44 extending vertically through openings 43, 45 in upper and lower flanged portions 46, 48 of the tray 40, and openings 26 in the partition member 25 (FIG. 3). While the locking members 44 may be mechanically linked to the lid 30 for movement therewith, in the illustrated embodiment, the locking members 44 are spring loaded (for example, by springs 42) and positioned such that an inner surface of the closed lid (FIG. 4) 30 pushes the locking members 44 into a locking condition, while the opened lid 30 (FIG. 5) allows the locking members to be spring biased into an unlocking condition. The upper ends of the locking members 44 may be rounded or padded to minimize marring of the internal surface of the lid 30. In the lid's closed position, as shown in FIG. 4, the retracted locking members 44 extend through aligned apertures 54 in the closed drawer 50 (for example, in rear tab brackets 56 secured to the drawer 50) to prevent withdrawal of the drawer 50 from the housing 20. When the lid 30 is opened, the locking members 44 slide out of engagement with the drawer apertures 54 to permit sliding movement of the drawer 50. The locking members 44 may be shaped to provide a laterally extending surface against which the springs 42 are biased. In the illustrated example, a stop ring 47 is secured to each locking member 44 (for example, by a set screw) to provide a bearing surface for the spring 42, and to provide an abutment with the upper tray flange 46 to limit the position of the extended locking member 44.

According to another aspect of the present application, a locking enclosure (such as, for example, a cash box) may be provided with a selectively attachable accessory container (such as, for example, a coin holder) that may be secured to an outer surface of the enclosure's housing when the enclosure is unlocked or opened. When detached from the housing, the accessory container may be sized to fit within the enclosure (e.g., within a storage tray or drawer), allowing the accessory container (and its contents) to be securely stored when the locking enclosure is closed and locked.

In the illustrated embodiment, a coin holder 60 is selectively attachable to a side surface of the enclosure housing 20. While many different types of attachment may be utilized, in the illustrated embodiment, the coin holder 60 includes tabs or buttons 65 (which may be integral with or affixed to the coin holder 60) sized for sliding engagement with corresponding slots 23 in an outer docking portion 21 of the housing 20. Such an attachment allows the coin holder 60 to be easily detached from the housing 20 for storage within the locked enclosure 10.

Additional features may be provided with the inventive locking enclosure. For example, the tray 40 and drawer 50 may include separate compartments 45, 55 for separating and organizing items within the enclosure. Spring biased retainers 41 may be provided for each compartment to hold items (such as paper money) within each compartment. Pockets 35 may be provided on the inner surface of the lid 30 to provide additional secure storage spaces.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A locking enclosure comprising:
a housing defining an opening;
a first access barrier movable between opened and closed positions to restrict access to an upper cavity within the housing;
a second access barrier movable between opened and closed positions to restrict access to a lower cavity within the housing, wherein movement of said second barrier from said closed position to said opened position is prohibited when said first barrier is in said closed position;
a locking mechanism that prohibits access to at least one of the upper cavity and the lower cavity when locked; and
a detachable storage compartment engaged to an outside surface of the housing.

2. The locking enclosure of claim 1 further comprising a tray for storing any contents of the upper cavity.

3. The locking enclosure of claim 1 wherein the first access barrier comprises a lid connected to the housing and adapted to cover the opening.

4. The locking enclosure of claim 1 wherein the second access barrier comprises a lockable drawer.

5. The locking enclosure of claim 1 wherein the locking mechanism prohibits access to the upper cavity and the lower cavity when locked.

6. The locking enclosure of claim 1 wherein the first access barrier is movable to an opened position only when the locking mechanism is unlocked.

7. A locking enclosure for use as a portable cash box, the locking enclosure comprising:
a housing having a base and four side walls;
a first access barrier movable between opened and closed positions to restrict access to an upper cavity within the housing;
a second access barrier movable between opened and closed positions to restrict access to a lower cavity within the housing; and
a locking mechanism that prohibits access to the upper cavity and lower cavity when locked;
wherein said second access barrier is movable from said closed position to said open position only when said first access barrier is in said opened position.

8. The locking enclosure of claim 7 further comprising a tray for storing any contents of the upper cavity.

9. The locking enclosure of claim 7 wherein the first access barrier comprises a lid rotatable about one of the four side walls.

10. The locking enclosure of claim 7 wherein the second access barrier comprises a lockable drawer.

11. The locking enclosure of claim 7 wherein the first access barrier is movable to an opened position only when the locking mechanism is unlocked.

12. The locking enclosure of claim 8 wherein contents of the lower cavity may be accessed without removing the tray from the housing.

13. The locking enclosure of claim 7 further comprising a detachable storage compartment that is removably engaged to one of the four side walls.

14. A cash box for storing paper notes and coins, the cash box comprising:
a housing having a base and four side walls;
a lid fixed to the housing and movable between opened and closed positions to restrict access to a tray within an upper cavity of the housing;
a drawer movable between a closed position within a lower cavity of the housing and an opened position at least partially extending from the housing;
a locking mechanism that prohibits access to the tray when locking the lid in a closed position;
at least one spring-loaded locking member which removably engages said lid to said drawer; and
a coin storage holder detachably engaged to one of the four side walls;

15. The cash box of claim 14 wherein the tray comprises dividers which define separate storage compartments and at least one retainer for securing contents of at least one storage compartment.

16. The cash box of claim 14 wherein the lid is lockable on a front side wall of the housing.

17. The cash box of claim 14 wherein the lid is movable to an opened position only when the locking mechanism is unlocked, and the drawer is movable to an opened position only when said locking member is disengaged from said lid.

18. The cash box of claim 14 wherein contents of the drawer may be accessed without removing the tray from the housing.

19. The cash box of claim 14 further comprising storage pockets on the inside surface of the lid.

20. The cash box of claim 15 where the at least one retainer is spring loaded so as to retain paper notes within the tray.
